(19) United States
(12) Patent Application Publication
(10) Pub. No.: US 2008/0113313 A1
(43) Pub. Date: May 15, 2008

(54) SELF CONTAINED COMPOSITION ENHANCING DENTAL TRAY

(76) Inventor: Louie Khouri, New York, NY (US)

Correspondence Address: HARNESS, DICKEY & PIERCE, P.L.C., P.O. BOX 828, BLOOMFIELD HILLS, MI, 48303, US

(21) Appl. No.: 11/940,492

(22) Filed: Nov. 15, 2007

Related U.S. Application Data
(60) Provisional application No. 60/865,877, filed on Nov. 15, 2006.

(51) Int. Cl. A61C 9/00

(52) U.S. Cl. 433/29; 433/37; 433/32

(57) ABSTRACT

The present invention relates to dental trays including a light source, a heat element or a combined light source and heating element that serves to enhance the treatment capacity of the composition. The dental tray is self-contained meaning that no external attachments that project from the mouth during use are required.

### CROSS-REFERENCE TO RELATED APPLICATIONS

This application claims the benefit of U.S. Provisional Application No. 60/865,877, filed on. Nov. 15, 2006. The disclosure of the above application is incorporated herein by reference.

### BACKGROUND

The present invention relates to dental trays, and more particularly, to dental trays including means for enhancing the effectiveness of a treatment composition disposed therein.

### DESCRIPTION OF RELATED ART

In conjunction with the relatively recent advancements in teeth whitening compositions, such as peroxides by way of non-limiting example, numerous apparatus have been developed to assist in applying such teeth whitening compositions. For example, various dental trays are now commercially available which are form fit, either at the dental office or at home, into which teeth whitening compositions are disposed prior to application to the teeth. While these devices are useful at maintaining the teeth whitening composition in contact with the teeth, they do not enhance the whitening effect of the composition.

Other known apparatus include dental trays having a light source or heating element associated within the tray. However, all such dental trays including some form of heating and/or illuminating element are known to be coupled to an external power source. As a result of external coupling requirements, the device becomes inconvenient to use. For example, an individual employing the device with external coupling may be precluded from moving about freely with the device inserted in the oral cavity. Further, even if mobility is a minor issue, another perceived problem is that many individuals would consider it unsightly to be out in public with a teeth whitening tray having an external coupling which is clearly visible.

Thus, the currently known devices suffer from the inability to enhance the whitening capacity of the composition, may not be suitable for allowing the patient to move about freely while the device is being utilized or are unsightly.

### SUMMARY

The present invention relates to a device for enhancing the effects of treatment compositions disposed within the dental tray and applied to the user's teeth. While the present invention will generally be described in terms of enhancing teeth whitening compositions, it should be understood that the present invention has broader applications. Regardless of the application, the dental tray will generally include a light source and/or a heating element coupled to the dental tray and a power source associated with the light source or heating element. The power supply for activating the light source and/or heat element is preferably integral with the tray and therefore is also disposed within the oral cavity. Thus, the dental tray and/or heat element of the present invention is “self contained” in that the device can essentially be fully disposed within the oral cavity during use so that the individual can freely move about, preferably with no portion of the device extending from the oral cavity during use.

The tray is sized such that the individual utilizing the device can close their mouth so as to conceal the apparatus during use. This allows an individual to utilize the device at the dental office, at home or out in public without worry.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of the illuminated bleaching tray according to the teachings of the present invention; and

FIG. 2 is a perspective view of an alternative embodiment of a dental tray according to the teachings of the present invention.

### DETAILED DESCRIPTION

The following description is merely exemplary in nature and is not intended to limit the present disclosure, application, or uses.

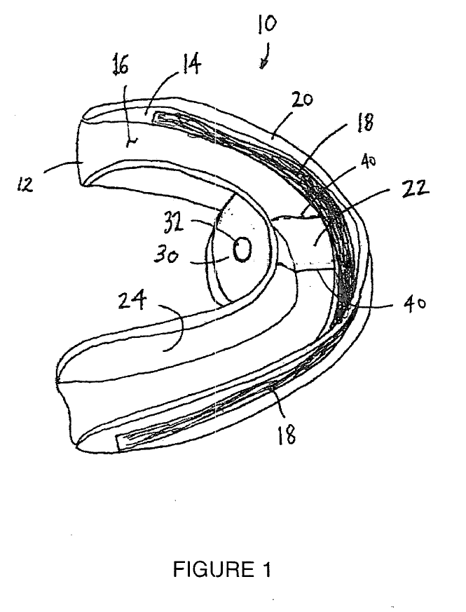

Referring to FIG. 1, there is shown a dental tray in accordance with the teachings of the present invention. The dental tray 10, which has, preferably, an overall U-shape which corresponds to a user's dental arch and is also generally U-shaped in cross-section, generally includes a body 12 formed from a suitable material such as plastics and/or rubber which are known in the art for manufacturing dental trays such as bleaching trays and the like. As can be appreciated by those skilled in the art, the plastic or rubber composition should be sufficiently translucent so as not to interfere with the electromagnetic radiation emanating from the light source and through the body of the tray. For embodiments employing a heating element, the dental tray need not be translucent. Examples of suitable materials for forming the tray include, by way of non-limiting example, polyethylenes, polypropylenes, ethyl vinyl acetates, and silicones. The tray is sized to fit comfortably within a person's mouth and includes a recess 16 within which the user's teeth are disposed in use. The recess 16 is defined by the area occurring between the inner and outer walls below the transverse wall. Thus, when disposed over the user's teeth, the outer wall 20 engages the outer surface of the user's teeth, the inner wall 24 engages the inner surface of the user's teeth and a transverse wall 22 engages the top of the user's teeth. While the tray may be generic, preferably it is formed from a material which is sufficiently pliable upon heating or otherwise softening so as to custom fit the user's mouth. If a generic tray is employed, it is also possible to use a translucent, bondable composition such as a polysiloxane material disposed within the recess 16 to convert the generic tray to a more form-fitting structure. In this regard, the composition is applied within the recess 16 of the tray and then the tray is positioned over the user's teeth such that the composition spreads onto the inner, outer and transverse walls. Once the composition has cured, the tray is removed from the user's mouth and can be trimmed down so long as the light source, or in some cases, the heating element remains fully intact.

As shown in the embodiment depicted in FIG. 1, embedded within the body of the tray along the forward wall 20 and, optionally, along the wall 22, which rests upon the top of the user's teeth, is an electromagnetic radiation source having the appropriate wavelength range to effectively enhance the effect of the whitening composition contained within the dental tray. While virtually any suitable light source 18 may be employed, it is preferred that the electromagnetic radiation source be a light emitting diode (LED) package configured to generate the suitable wavelength range. LED packages are preferable as light sources because they do not generate significant heat that can, under certain circumstances, be problematic when disposed within the oral cavity. Disposed between the LED package and the portion of the tray body disposed against the teeth to be treated may be a diffuser (not shown) to ensure that the appropriate amount of electromagnetic radiation is allowed to activate the treatment composition such as a teeth whitening composition, for example.

The LED package may be a single elongated LED strip or an array of LEDs disposed on a flexible circuit band. The LED package is determined and chosen to optimize the whitening effect of the composition to be used.

In addition to the possibility of utilizing a diffuser between the light source and the tray portion disposed against the teeth, it may also be beneficial to employ a reflector (not shown) behind the electromagnetic radiation source in proximity to the outer wall 24 to assist in directing the generated light toward the teeth being treated with the composition.

Coupled to the dental tray in electrical communication through lead wires 40 with the light source or heating element is a power source 30. The power source extends from the tray proper along the concave portion 44 of the inner wall 24, generally toward the back of the oral cavity such that the dental tray can be inserted and maintained within the user's oral cavity and away from the light source or heating element and hidden from view if the user's mouth is closed. The power source is a battery package capable of activating the light source or heating element, in some cases, for a predetermined period of time, such as from between about ten minutes to approximately one hour, for teeth whitening compositions. The power source 30 can be embedded as part of the tray body at the time of formation, or, preferably, is selectively detachable from the tray body so that it can be readily replaced. Additionally, the power source includes an appropriate on/off switch, such as a push button 32 by way of non-limiting example, for activating and deactivating the light source and/or heating element.

In addition to the power supply, the tray proper or the battery package may also include means for adjusting the wavelength and/or timing of the light source activation utilizing a microprocessor. This would assist in ensuring that the user of the device does not overexpose their teeth when used outside of the dental office.

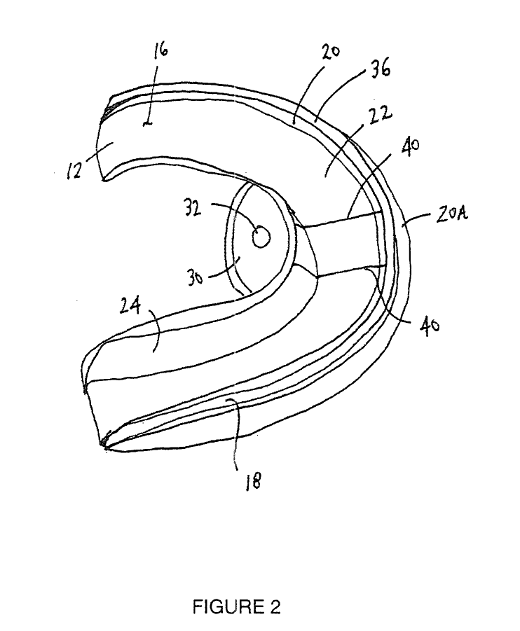

Under an alternate embodiment of the present invention as shown in FIG. 2, the light source or heating element may be selectively removable from the body of the tray to allow for replacement. In this regard, the light source, such as an LED strip or heating element, is press fit into a slot 36 occurring along the length of the front wall, which is now separated by the slot into portions 20, and 20A. The embodiment is beneficial not only for substitution of the light source or heating element when necessary, but, also reduces the chances of damaging the light source or heating element when the tray body 12 is being form fit to the user's teeth. With the light source or heating element removed from the tray, a similarly sized durable plastic band (not shown) can be inserted into the slot 36 prior to heating or otherwise softening the tray to custom fit the device to the user's teeth. As should be appreciated, this will serve to maintain the integrity of the slot for receipt of the light source, or in some cases, a heating element, after the tray is custom fit.

In order to use the above-described devices, the user will generally first soften the dental tray and press-fit the tray within the oral cavity to fit over the upper or lower teeth to provide a customized fitting. Thereafter, upon sufficient cooling, a treatment composition is disposed within the tray such that upon reinsertion of the tray over the teeth, the composition is in direct contact with the teeth. Thereafter the light source or heating element is activated for a sufficient amount of time to carry out the procedure. As with any dental procedure, it is recommended that the device be used under the supervision of a dental practitioner who can assist in selecting the appropriate treatment composition and use times to obtain the desired results without damaging the user's teeth.

While the above-described device is particularly suited for use in whitening the user's teeth, it should be clear that the device can also be used as a treatment delivery mechanism for delivering compositions to the teeth or gums, particularly compositions that can be activated or otherwise enhanced by electromagnetic radiation and/or heat.

The description of the invention is merely exemplary in nature and, thus, variations that do not depart from the gist of the invention are intended to be within the scope of the invention.

What is claimed is:

1. A self-contained dental tray comprising:
a body having an elongated recess for receiving a treatment composition for teeth;
a light source or heating element capable of enhancing the treatment capacity of the treatment composition coupled to said tray; and
a power source for activating said light source or heating element;
whereby when said dental tray is disposed over a user's teeth, the user may close their mouth to fully conceal the tray during periods of use.

2. The self-contained dental tray of claim 1, wherein said light source or heating element is selectively detachable from said tray.

3. The self-contained dental tray of claim 1 wherein said light source or heating element is permanently embedded within the body of said tray.

4. The self-contained dental tray of claim 1, wherein said light source is an LED source.

5. The self-contained dental tray of claim 4, wherein said LED is an array of imbedded LED lights disposed along a flexible circuit member.

6. The self-contained tray of claim 1 wherein said power source is a battery package in electrical communication with said light source or heating element.

7. The self-contained dental tray of claim 5, wherein said power source is selectively detachable from said tray.

8. A self-contained dental tray comprising:
a substantially U-shaped body including an elongated recess for receiving a treatment composition for teeth;
a light source or heating element capable of enhancing the treatment capacity of the treatment composition coupled to said tray; and
a power source electrically connected to said light source or heating element;
whereby when said dental tray is disposed over a user's teeth, the user may close their mouth to fully conceal the tray during periods of use.

9. The self-contained dental tray of claim 8, wherein said light source or heating element is selectively detachable from said tray.

10. The self-contained dental tray of claim 8 wherein said light source or heating element is permanently embedded within the body of said tray.

11. The self-contained dental tray of claim 8, wherein said light source is an LED source.

12. The self-contained dental tray of claim 11, wherein said LED is an array of imbedded LED lights disposed along a flexible circuit member.

13. The self-contained tray of claim 9 wherein said power source is a battery package in electrical communication with said light source or heating element.

14. A self-contained dental tray comprising:
a substantially U-shaped body including an inner wall, an outer wall and a transverse wall defining an elongated recess for receiving a treatment composition for teeth;
a light source capable of enhancing the treatment capacity of the treatment composition coupled to said tray; and
a power source coupled to the inner wall of said body and electrically connected to said light.

15. The self-contained dental tray of claim 14, wherein said light source or heating element is selectively detachable from said tray.

16. The self-contained dental tray of claim 14 wherein said light source or heating element is permanently embedded within the body of said tray.

17. The self-contained dental tray of claim 14, wherein said light source is an LED source.

18. The self-contained dental tray of claim 17, wherein said LED is an array of imbedded LED lights disposed along a flexible circuit member.

19. The self-contained tray of claim 14 wherein said power source is a battery package in electrical communication with said light source or heating element.

20. The self-contained dental tray of claim 18, wherein said power source is selectively detachable from said tray.
